(19) United States
(12) Patent Application Publication
(10) Pub. No.: US 2026/0004024 A1
(43) Pub. Date: Jan. 1, 2026

(54) PREDICTION METHOD FOR RESPONSE OF REFINED FINITE ELEMENT MODELS OF COMPLEX STRUCTURE

(71) Applicants: JIANGXI UNIVERSITY OF SCIENCE AND TECHNOLOGY, Ganzhou (CN); HOHAI UNIVERSITY, Nanjing (CN)

(72) Inventors: Maosen CAO, Nanjing (CN); Yifei LI, Nanjing (CN); Tongfa DENG, Ganzhou (CN); Li CHEN, Nanjing (CN); Drahomír Novak, Nanjing (CN); Dragoslav SUMARAC, Nanjing (CN); Qingyang WEI, Nanjing (CN); Zeyu WANG, WANG (CN)

(73) Assignees: JIANGXI UNIVERSITY OF SCIENCE AND TECHNOLOGY, Ganzhou, JX (CN); HOHAI UNIVERSITY, Nanjing, JS (CN)

(21) Appl. No.: 18/755,734

(22) Filed: Jun. 27, 2024

(51) Int. Cl. G06F 30/23; G06F 111/08

(52) U.S. Cl. CPC G06F 30/23; G06F 2111/08

(57) ABSTRACT

The invention provides a prediction method for the response of a refined finite element model of a complex structure. It includes establishing a refined finite element model and a rough mirror information model with different mesh densities; using Latin Hypercube Sampling (LHS) for random sampling to construct input parameter sample sets of sizes m and n; performing probabilistic finite element analysis and extracting output response sample sets; constructing a Kriging model based on the first m sets of data in the output response sample sets, and using validation error to evaluate predictive accuracy; predicting the output response of the refined finite element model corresponding to the remaining n−m sets of data in the response sample sets of the rough mirror information model according to the Kriging model. This method reduces surrogate model's dependence on the forward calculation model's fineness and significantly reduces calculation time for system response of complex structures.

### TECHNICAL FIELD

The present invention relates to the field of structural engineering technology, in particular to a method for predicting the response of a refined finite element model of a complex structure based on a Kriging model-driven rough mirror information model.

### BACKGROUND ART

In the world, many pre-safety and stability assessments of complex structures rely on numerical simulation methods, one of the most commonly used methods is to establish a refined finite element model for complex structures to help engineers study the real behavior and performance of structures as closely as possible.

However, there are also many shortcomings in the use of refined structural finite element models for numerical simulation, for example, the efficiency of numerical calculation depends heavily on the fineness of the structural finite element model, resulting in a leap-forward increase in the time to obtain the response of the refined structural finite element model with the complexity of the structural finite element model, especially when it is necessary to perform dynamic response analysis (modal analysis, transient analysis, etc.), the use of refined structural finite element models undoubtedly puts extremely stringent requirements on the memory and computing power of the computer.

To this end, the present application proposes a method for predicting the response of a refined finite element model of a complex structure by a rough mirror information model.

### SUMMARY

In order to solve the above problems, the present invention proposes a method for predicting the response of a refined finite element model of a complex structure based on a Kriging model-driven rough mirror information model.

In order to achieve the above objective, the present invention provides the following technical scheme.

A prediction method for response of refined finite element model of complex structure, comprising the following steps:
according to the complex structure to be predicted, establishing a refined finite element model to characterize characteristics of a structural physical model system and a rough mirror information model twinned with the refined finite element model and has different mesh density;
determining probability distribution types of the material parameters in the refined finite element model and the rough mirror information model based on a prior knowledge, and using a Latin Hypercube Sampling (LHS) method for random sampling to construct input parameter sample sets with sizes of m and n, respectively;
according to the input parameter sample sets, performing a probabilistic finite element analysis on the rough mirror information model and the refined finite element model respectively, and extracting corresponding output response sample sets;
constructing a Kriging model based on a first m sets of data in the output response sample sets of the rough mirror information model and the refined finite element model, and using a validation error to evaluate a predictive accuracy and reconstruct the Kriging model;
predicting an output response of the refined finite element model corresponding to a remaining n−m sets of data in the response sample sets of the rough mirror information model according to the Kriging model.

Preferably, an input parameter of the input parameter sample set comprises a material parameter and a boundary condition; where n≥5 m.

Preferably, the output response comprises frequency, displacement, and stress.

Preferably, the Kriging model M^{krg}(x) is shown as follows:

$$Y \approx {ℳ}^{Krg} ( x ) = {ϑ}^{T} F ( x ) + G ( x )$$

where θ^{T} is a transpose of a corresponding regression coefficient vector, F(x)=[F₁(x), . . . , F_{M}(x)] is a polynomial basis function, θ^{T}F(x) is a trend of the Kriging model, and G(x) is a Gaussian process with a mean value of zero.

Preferably, the construction of the Kriging model also comprises the following steps:
constructing a covariance function of G(x) to correlate with a hyper-parameter in the Kriging model;
calibrating the hyper-parameter in the Kriging model M^{krg}(x).

Preferably, the construction of the covariance function of G(x) comprises the following steps:
defining G(x):

$$G ( x ) = Cov ( G ( {x}_{i} ) , G ( {x}_{j} ) ) = {σ}^{2} R ( {x}_{i} , {x}_{j} ; θ )$$

where xᵢ and xⱼ are a pair of sampling points in a sample space of a structural output response, and G(xᵢ) and G(xⱼ) are an observed value and a new interpolation, respectively; σ² is a constant variance of G(x); R(xᵢ, xⱼ; θ) is a correlation function, which describes a similarity between G(xᵢ), G(xⱼ) and a correlation coefficient θ=[θ₁, . . . , θₙ]^{T};
Matérn-5/2 as a correlation function, the formula is as follows:

$$R ( {x}_{i} , {x}_{j} ; θ , v = 5 / 2 ) = 1 + \sqrt{5} \frac{\vert {x}_{i} - {x}_{j} \vert}{θ} + \frac{5}{3} {( \frac{\vert {x}_{i} - {x}_{j} \vert}{θ} )}^{2} ) exp [ - \sqrt{5} \frac{\vert {x}_{i} - {x}_{j} \vert}{θ} ] .$$

Preferably, the calibration of the hyper-parameter in the Kriging model M^{krg}(x) comprises the following steps:
considering that y={M(x⁽¹⁾), . . . , M(x^{(N)})}^{T} assumes to obey a multivariate Gaussian distribution, estimating an unknown hyper-parameter γ=(θ, σ², θ) in the Kriging model by maximizing a likelihood function, as follows:

$$ℒ ( γ ; 𝒴 ) = \frac{{( det C )}^{- 1 / 2}}{{( 2 π )}^{N / 2}} exp [ - \frac{1}{2} {( 𝒴 - P ϑ )}^{T} {C}^{- 1} ( 𝒴 - P ϑ ) ]$$

where C=σ²R+Σₙ is a covariance matrix, En is a noise response, P=[p(x₁), . . . p(x_{N})]^{T} is an N×M regression matrix of an element Pᵢⱼ=pⱼ(xᵢ);
a partial derivative of the above formulas about θ and σ² are solved and set to zero, the solution of θ is transformed into solving the following optimization problems:

$$\hat{θ} = {arg min}_{θ ∈ {D}_{θ}} [ - log ℒ ( θ ; 𝒴 ) ] = arg {min}_{θ ∈ {D}_{θ}} \frac{1}{2} [ log ( det R ) + N log ( 2 {πσ}^{2} ) + N ]$$

where D_{θ} is a parameter space of θ, and R is an abbreviation of R(xᵢ, xⱼ; θ).

Preferably, the validation error is used to evaluate the predictive accuracy and reconstruct the Kriging model, comprising the following steps:
evaluating the accuracy of Kriging model by a leave-one-out cross validation error until the accuracy of the model meets the requirements; otherwise, repeatedly constructing an input-output data set of the structure to be analyzed, and then re-establishing the Kriging model until the accuracy of the model meets the preset requirements;
wherein, the accuracy of the Kriging model is evaluated by the leave-one-out cross validation error according to the following formula,

$${Err}_{LOO} = \frac{{\sum }_{j = 1}^{N} {( ℳ ( {x}^{( j )} ) - {ℳ}^{Krg \backslash j} ( {x}^{( j )} ) )}^{2}}{{\sum }_{j = 1}^{N} {( ℳ ( {x}^{( j )} ) - {\hat{μ}}_{Y} )}^{2}}$$

where M(x^{(j)}) is a sample value of the structural output response at the j^{th} sample point, M^{Krg\j}(x^{(j)}) is a predicted value of the structural output response of the Kriging model excluding the j^{th} sample point, and

$${\hat{μ}}_{Y} = \frac{1}{N} {\sum }_{j = 1}^{N} ℳ ( {x}^{( j )} )$$

is an average value of the structural output response sample set.

The beneficial effects of the present invention are as follows:

The present invention provided a method for predicting the response of a refined finite element model of a complex structure based on a Kriging model-driven rough mirror information model, considers the prior uncertainty of the input parameters, and performs probabilistic finite element analysis to reduce the hypothesis error of the finite element model parameters. By establishing the rough mirror information model corresponding to the refined finite element model of complex structure, the generation AI technology is used to expand the surrogate model database, which effectively reduces the dependence of the efficiency of surrogate model on the fineness of the forward calculation model, and greatly reduces the calculation time of the refined finite element model of complex structure to obtain the system response.

### BRIEF DESCRIPTION OF THE DRAWINGS

FIG. 1 is a flow chart of a method for predicting the response of a refined finite element model of a complex structure based on a Kriging model-driven rough mirror information model in an embodiment of the present invention;

FIG. 2 is a schematic diagram of the basic principle in an embodiment of the present invention;

FIG. 3 is a refined finite element model M-1 and its twinned rough mirror information model M-2 in an embodiment of the present invention;

FIG. 4 is a layout diagram of an important sampling point of a dam body in an embodiment of the present invention;

FIG. 5 is a Kriging model validation and prediction diagram of an X-direction displacement response of the corresponding M-1 and M-2 at a sampling point 1 in an embodiment of the present invention and;

FIG. 6 is a scatter diagram of a first 20 natural frequency true response and Kriging model response of M-1 in an embodiment of the present invention.

### DETAILED DESCRIPTION OF THE EMBODIMENTS

In order to make the objective, technical solution, and advantages of the present invention clearer and more specific, the present invention will be further described in detail below with reference to accompanying drawings and embodiments. It should be understood that the specific examples described herein are merely illustrative of the present invention and are not intended to limit the present invention.

### Embodiment 1

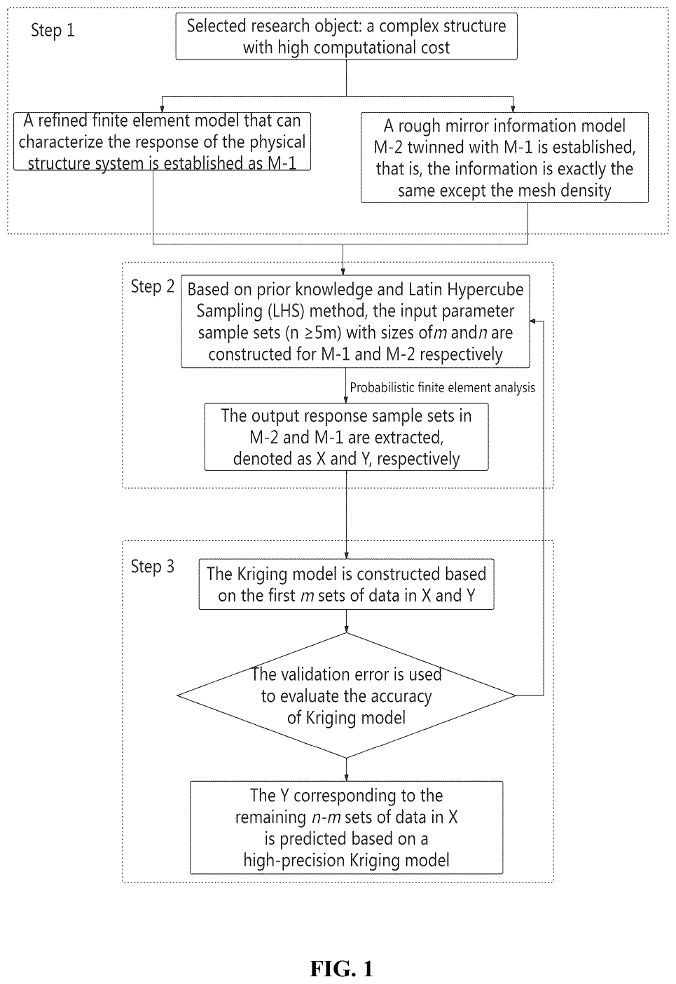

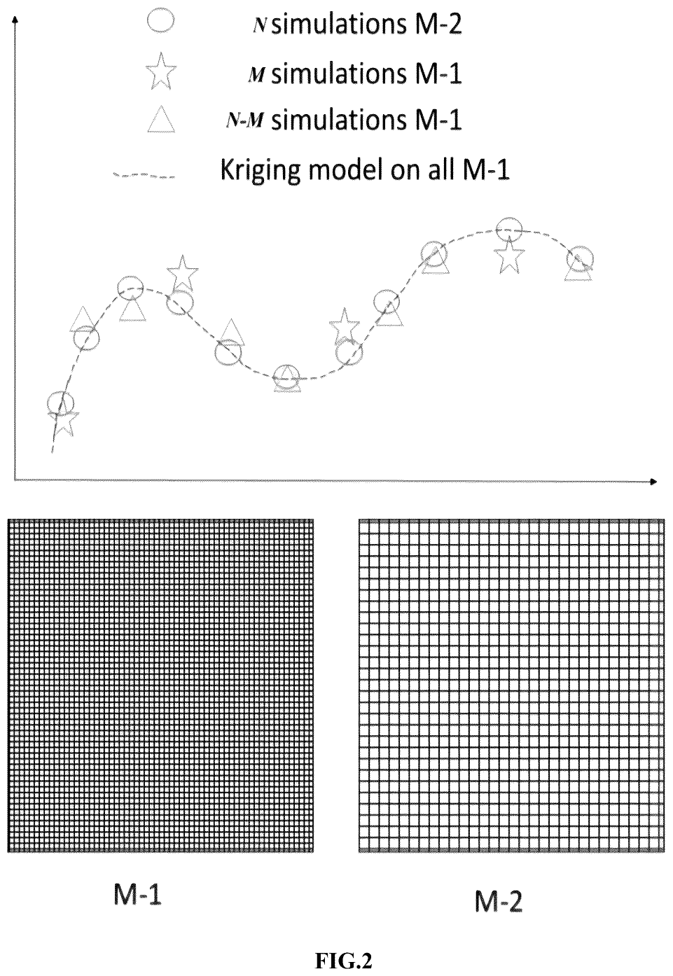

A prediction method for response of refined finite element model of complex structure of the present invention, as shown in FIG. 1, comprises the following steps:
S1: a complex structure with a high computational cost is selected as the research object, two sets of finite element models with different mesh densities are established for the research object, which are denoted as M-1 and M-2, respectively, where M-1 is a refined finite element model that can characterize the characteristics of the structural physical model system, and M-2 is a rough mirror information model twinned with M-1. The schematic diagram of the basic principle is shown in FIG. 2.
S2: the probability distribution types of the material parameters in M-1 and M-2 are determined based on a prior knowledge, and the LHS method is used for random sampling in its probability space and to construct the input parameter sample sets (n≥5 m) with sizes of m and n for M-1 and M-2, respectively.
S3: a probabilistic finite element analysis is performed and the corresponding output response sample sets in M-2 and M-1 are extracted, denoted as X and Y, respectively.
S4: the Kriging model is constructed based on the first m sets of data in X and Y, and the validation error is used to evaluate the predictive accuracy.
S5: the Y corresponding to the remaining n−m sets of data in X is predicted based on a high-precision Kriging model.

Wherein the steps of establishing the Kriging surrogate model M^{krg}(x) comprise:
the Kriging surrogate model is constructed by using the first m sets of output response sample data in M-1 and M-2; the accuracy of Kriging model is evaluated by a leave-one-out cross validation error until the accuracy of the model meets the requirements (in general, Err_{LOO}≤1.0E-5 in pure numerical problems, Err_{LOO}≤1.0E-3 in engineering problems); otherwise, the ‘input-output’ data set of the structure to be analyzed is repeatedly constructed, and the Kriging model is re-established until the accuracy of the model meets the preset requirements;
the Kriging surrogate model M^{krg}(x) is constructed by using the following formula:

$$Y = {ℳ}^{Krg} ( x ) = {ϑ}^{T} F ( x ) + G ( x )$$

where θ^{T} is a transpose of a corresponding regression coefficient vector, F(x)=[F₁(x), . . . , F_{M}(x)] is a polynomial basis function, θ^{T}F(x) is a trend of the Kriging model, and G(x) is a Gaussian process with a mean value of zero.

Further, the steps of the Kriging surrogate model M^{krg}(x) comprise:
a covariance function of G(x) is constructed to correlate with a hyper-parameter in the Kriging model;
the hyper-parameter in the Kriging model M^{krg}(x) is calibrated.

Specifically, the construction of the covariance function of G(x) comprises:
G(x) is defined as follows:

$$G ( x ) = Cov ( G ( {x}_{i} ) , G ( {x}_{j} ) ) = {σ}^{2} R ( {x}_{i} , {x}_{j} ; θ )$$

where xᵢ and xⱼ are a pair of sampling points in a sample space of a structural output response, and G(xᵢ) and G(xⱼ) are an observed value and a new interpolation, respectively; σ² is a constant variance of G(x); R(xᵢ, xⱼ; θ) is a correlation function, which describes a ‘similarity’ between G(xᵢ), G (xⱼ) and a correlation coefficient θ=[θ₁, . . . , θₙ]^{T};
the appropriate correlation function is selected, the Matérn-5/2 correlation function with strong smoothness and high universality is selected in this study, the formula is as follows:

$$R ( {x}_{i} , {x}_{j} ; θ , ν = 5 / 2 ) = 1 + \sqrt{5} \frac{\vert {x}_{i} - {x}_{j} \vert}{θ} + \frac{5}{3} {( \frac{\vert {x}_{i} - {x}_{j} \vert}{θ} )}^{2} ) exp [ - \sqrt{5} \frac{\vert {x}_{i} - {x}_{j} \vert}{θ} ] .$$

Specifically, the step of calibrating the hyper-parameter in the Kriging model M^{krg}(x) comprises:
considered that y={M(x⁽¹⁾), . . . , M(x^{(N)})}^{T} assumes to obey a multivariate Gaussian distribution, an unknown hyper-parameter γ=(θ, σ², θ) in the Kriging model is estimated by maximizing a likelihood function, as follows:

$$ℒ ( γ ; 𝓎 ) = \frac{{( det C )}^{- 1 / 2}}{{( 2 π )}^{N / 2}} exp [ - \frac{1}{2} {( 𝓎 - P ϑ )}^{T} {C}^{- 1} ( 𝓎 - P ϑ ) ]$$

where C=σ²R+Σₙ is a covariance matrix, En is a noise response, P=[p(x₁), . . . p(x_{N})]^{T} is an N×M regression matrix of an element Pᵢⱼ=pⱼ(xᵢ).

A partial derivative of the above formulas about θ and σ² are solved and set to zero, therefore the solution of θ is transformed into solving the following optimization problems:

$$\hat{θ} = arg {min}_{θ ∈ {D}_{θ}} [ - log ℒ ( θ ; 𝓎 ) ] = arg {min}_{θ ∈ {D}_{θ}} \frac{1}{2} ( log ( det R ) + N log ( 2 {πσ}^{2} ) + N ]$$

where D_{θ} is a parameter space of θ, and R is an abbreviation of R(xᵢ, xⱼ; θ).

Specifically, the accuracy of the Kriging model is evaluated by the leave-one-out cross validation error according to the following formula,

$${Err}_{LOO} = \frac{{\sum }_{j = 1}^{N} {( ℳ ( {x}^{( j )} ) - {ℳ}^{Krg \backslash j} ( {x}^{( j )} ) )}^{2}}{{\sum }_{j = 1}^{N} {( ℳ ( {x}^{( j )} ) - {\hat{μ}}_{Y} )}^{2}}$$

where M(x^{(j)}) is a sample value of the structural output response at the j^{th} sample point, M^{Krg\j}(x^{(j)}) is a predicted value of the structural output response of the Kriging model excluding the j^{th} sample point, and

$${\hat{μ}}_{Y} = \frac{1}{N} {\sum }_{j = 1}^{N} ℳ ( {x}^{( j )} )$$

is an average value of the structural output response sample set.

In the embodiment:
a real large and complex high arch dam structure is taken as an example to carry out a research on the method for predicting the response of a fine finite element model of a complex structure based on a Kriging model-driven rough mirror information model. The high arch dam is a concrete double-curvature arch dam with a height of 95 meters, three spillway holes are arranged in the middle of the dam crest, the crest elevation of the dam is 643.5 meters, and the net width of each hole is 10.0 meters. The dam was completed in November 2015 and began impounding water in February 2017 until the completion of impoundment at the end of July 2017.

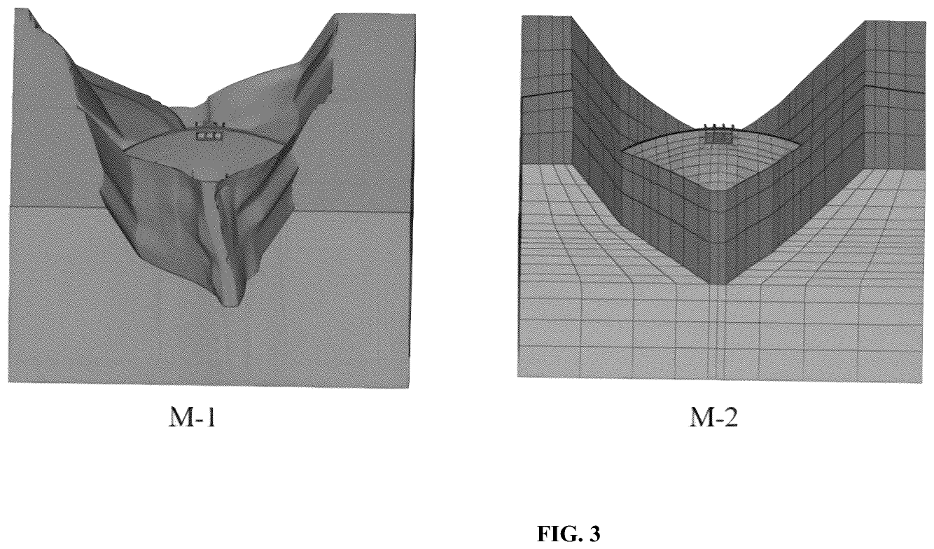

The refined finite element model M-1 and its twinned rough mirror information model M-2 of the arch dam are both constructed by hexahedral and tetrahedral SOLID185 elements in the large commercial modeling software HyperMesh. In order to simplify the complexity of the problem, the high arch dam structure only considers two large partitions, the dam body and the foundation. The specific drawings are shown in FIG. 3, the other characteristics (load, boundary conditions, material parameters, etc.) of M-1 and M-2 are the same except for different mesh densities, the basic mesh parameters of the two are given in Table 1.

TABLE 1
Basic grid parameters of high arch dams M-1 and M-2

| | M-1 | M-2 | N_{M-2}/N_{M-1} |
|---|---|---|---|
| Number of dam units | 42712 | 675 | 1.58% |
| Number of overall units | 201728 | 2171 | 1.08% |

In this embodiment, the superiority of the method shown in the present invention is verified mainly from two aspects, structural static analysis and modal analysis. Firstly, the material parameter setting probability in the model is input into the prior model based on the prior knowledge, such as Table 2; then, the Latin Hypercube Sampling (LHS) method is used to perform 500 sets of probability sampling on the material parameters in the parameter probability space; wherein, M-1 uses the first 100 sets to perform probabilistic finite element analysis, and M-2 uses the full-size material parameter sample sets to perform probabilistic finite element analysis, then the output response sample sets corresponding to these two is extracted, that is, M-1 corresponds to 100 sets of sample data, and M-2 corresponds to 500 sample data; the Kriging model is constructed based on the first 100 sets of output response samples in M-1 and M-2, of which the first 50 sets are used for experimental design and the last 50 sets are used to verify the accuracy of the Kriging model; finally, the generated high-precision Kriging model is used to predict the output response of M-1 based on the remaining 400 sets of output responses in M-2.

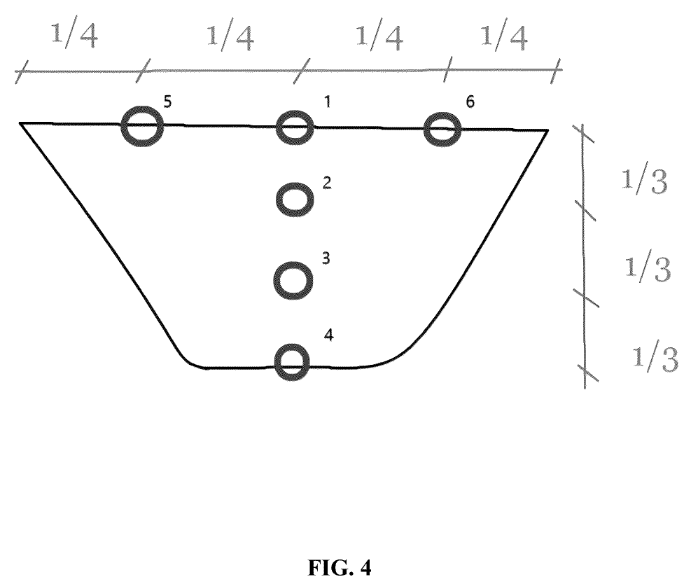

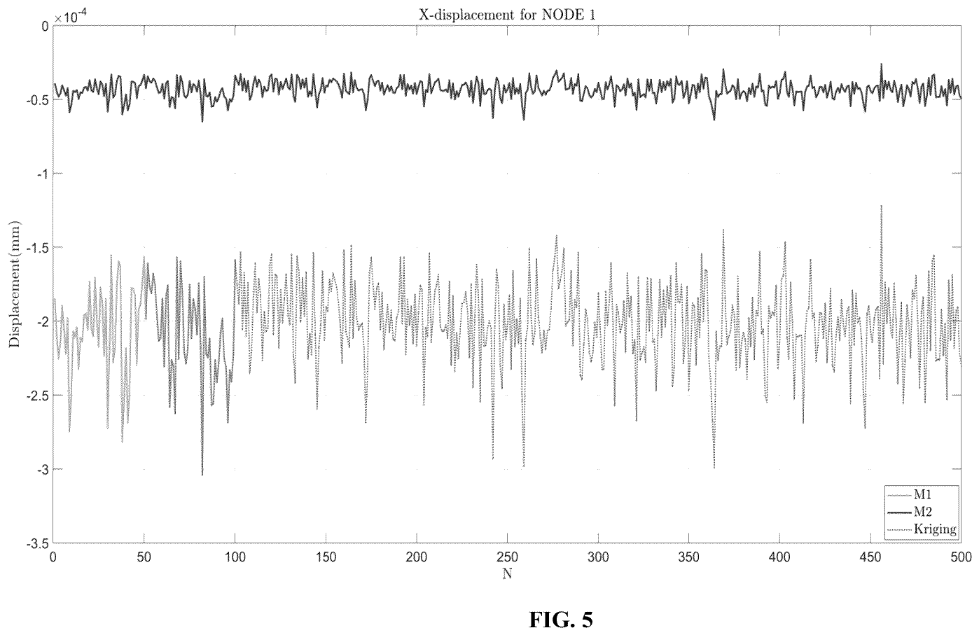

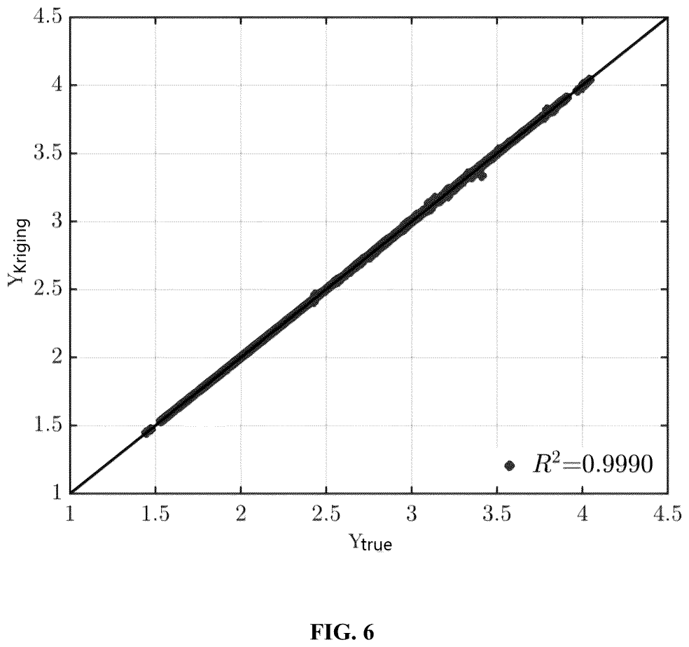

In this embodiment, all numerical computing environments are based on high-performance UNIX workstations, the workstation has a double-node, each node has a 36-core CPU and 192 G memory, and the calculation software uses ANSYS APDL and performs finite element analysis by calling 12 threads. The output response extracted by the static analysis of the structure is M-1 and M-2 corresponding to the X-direction displacement at the sampling point 1 in FIG. 4, and the output response extracted by the modal analysis is the first 20 natural frequencies of M-1 and M-2. FIG. 5 is the Kriging model validation and prediction diagram of the X-direction displacement response of M-1 and M-2 at a sampling point 1, it can be clearly seen from the diagram that the 50 sets of validation sets and their corresponding Kriging model prediction sets completely coincide, and the Kriging model corresponding to the displacement response leave-one-out validation error Err_{LOO}=1.08E-08, fully meet the accuracy requirements. FIG. 6 is the scatter diagram of the first 20 natural frequency true response validation sets and the Kriging model response prediction set of M-1, it can be seen that both of them are basically distributed on the scatter trend line, and the R² is as high as 0.999. The ultra-high precision performance of the Kriging model in these two aspects shows the effectiveness and excellent performance of the proposed method in the present invention.

TABLE 2
Probabilistic input prior model of material
parameters of high arch dam M-1 and M-2

| Parti- | | | | Probabilistic |
|---|---|---|---|---|
| tion | Material | Symbols and | Distribution | distribution |
| name | parameters | units | function | model |
| Dam | Elastic modulus | E1[GPa] | Gaussian | N(20, 2) |
| | | | distribution | |
| | Density | ρ1[kg/m³] | Gaussian | N(2400, 240) |
| | | | distribution | |
| Basics | Elastic modulus | E2 | Gaussian | N(12, 1.2) |
| | | | distribution | |
| | Density | ρ2 | Gaussian | N(2200, 220) |
| | | | distribution | |

TABLE 3
The calculation time of high arch dam M-1 and M-2 to obtain the output response

| | | | Calculation time | Calculation time ratio |
|---|---|---|---|---|
| | Computation time | Computation time | of M-1 based on | of predicted M-1 to |
| Output | of M-1 | of M-2 | M-2 prediction | actual M-1 |
| response | (100 simulations) | (500 simulations) | (400 simulations) | (400 simulations) |
| Displacement | 3.567 | 0.194 | 0.155 | 3.567*4/0.155 = 92.05 |
| Frequency | 9.989 | 1.035 | 0.828 | 9.989*4/0.828 = 48.26 |

The above embodiment confirms that the present invention effectively reduces the dependence of the efficiency of surrogate model on the fineness of the forward calculation model, and greatly reduces the calculation time of the complex structure to obtain the system response.

The above examples are merely preferred embodiments of the present invention, but not intended to limit the present invention, and any modifications, equivalent replacements, improvements, etc. made within the spirit and principles of the disclosure should fall within the scope of protection of the present invention.

What is claimed is:

1. A prediction method for response of refined finite element model of complex structure, comprising the following steps: according to the complex structure to be predicted, establishing a refined finite element model to characterize characteristics of a structural physical model system and a rough mirror information model twinned with the refined finite element model and has different mesh density; determining probability distribution types of the material parameters in the refined finite element model and the rough mirror information model based on a prior knowledge, and using a Latin Hypercube Sampling (LHS) method for random sampling to construct input parameter sample sets with sizes of m and n, respectively; according to the input parameter sample sets, performing a probabilistic finite element analysis on the rough mirror information model and the refined finite element model respectively, and extracting corresponding output response sample sets; constructing a Kriging model based on a first m sets of data in the output response sample sets of the rough mirror information model and the refined finite element model, and using a validation error to evaluate a predictive accuracy and reconstruct the Kriging model; predicting an output response of the refined finite element model corresponding to a remaining n−m sets of data in the response sample sets of the rough mirror information model according to the Kriging model.

2. The prediction method for response of refined finite element model of complex structure according to claim 1, an input parameter of the input parameter sample set comprises a material parameter and a boundary condition; where n≥5 m.

3. The prediction method for response of refined finite element model of complex structure according to claim 1, the output response comprises frequency, displacement, and stress.

4. The prediction method for response of refined finite element model of complex structure according to claim 1, the Kriging model M^{krg}(x) is shown as follows:
$$Y = {ℳ}^{Krg} ( x ) = {ϑ}^{T} F ( x ) + G ( x )$$
where θ^{T} is a transpose of a corresponding regression coefficient vector, F(x)=[F₁(x), . . . , F_{M}(x)] is a polynomial basis function, θ^{T}F(x) is a trend of the Kriging model, and G(x) is a Gaussian process with a mean value of zero.

5. The prediction method for response of refined finite element model of complex structure according to claim 4, a construction of the Kriging model also comprises the following steps: constructing a covariance function of G(x) to correlate with a hyper-parameter in the Kriging model; calibrating the hyper-parameter in the Kriging model M^{krg}(x).

6. The prediction method for response of refined finite element model of complex structure according to claim 5, the construction of the covariance function of G(x) comprises the following steps:
$$defining G ( x ) : G ( x ) = Cov ( G ( {x}_{i} ) , G ( {x}_{j} ) ) = {σ}^{2} R ( {x}_{i} , {x}_{j} ; θ )$$
where xᵢ and xⱼ are a pair of sampling points in a sample space of a structural output response, and G(xᵢ) and G(xⱼ) are an observed value and a new interpolation, respectively; σ² is a constant variance of G(x); R(xᵢ, xⱼ; θ) is a correlation function, which describes a similarity between G(xᵢ), G(xⱼ) and a correlation coefficient θ=[θ₁, . . . , θₙ]^{T}; wherein, a correlation function is Matérn-5/2 correlation function, the formula is as follows:
$$R ( {x}_{i} , {x}_{j} ; θ , ν = 5 / 2 ) = 1 + \sqrt{5} \frac{\vert {x}_{i} - {x}_{j} \vert}{θ} + \frac{5}{3} {( \frac{\vert {x}_{i} - {x}_{j} \vert}{θ} )}^{2} ) exp [ - \sqrt{5} \frac{\vert {x}_{i} - {x}_{j} \vert}{θ} ] .$$

7. The prediction method for response of refined finite element model of complex structure according to claim 5, the calibration of the hyper-parameter in the Kriging model M^{krg}(x) comprises the following steps: considering that y={M(x⁽¹⁾), . . . , M(x^{(N)})}^{T} assumes to obey a multivariate Gaussian distribution, estimating an unknown hyper-parameter γ=(θ, σ², θ) in the Kriging model by maximizing a likelihood function, as follows:
$$ℒ ( γ ; 𝓎 ) = \frac{{( det C )}^{- 1 / 2}}{{( 2 π )}^{N / 2}} exp [ - \frac{1}{2} {( 𝓎 - P ϑ )}^{T} {C}^{- 1} ( 𝓎 - P ϑ ) ]$$
where C=σ²R+Σₙ is a covariance matrix, En is a noise response, P=[p(x₁), . . . p(x_{N})]^{T} is an N×M regression matrix of an element Pᵢⱼ=pⱼ(xᵢ); a partial derivative of the above formulas about θ and σ² are solved and set to zero, the solution of θ is transformed into solving the following optimization problems:
$$\hat{θ} = arg {min}_{θ ∈ {D}_{θ}} [ - log ℒ ( θ ; 𝓎 ) ] = arg {min}_{θ ∈ {D}_{θ}} \frac{1}{2} ( log ( det R ) + N log ( 2 {πσ}^{2} ) + N ]$$
where D_{θ} is a parameter space of θ, and R is an abbreviation of R(xᵢ, xⱼ; θ).

8. The prediction method for response of refined finite element model of complex structure according to claim 1, the validation error is used to evaluate the predictive accuracy and reconstruct the Kriging model, comprising the following steps: evaluating the accuracy of Kriging model by a leave-one-out cross validation error until the accuracy of the model meets the requirements; otherwise, repeatedly constructing an input-output data set of the structure to be analyzed, and then re-establishing the Kriging model until the accuracy of the model meets the preset requirements;
wherein, the accuracy of the Kriging model is evaluated by the leave-one-out cross validation error according to the following formula,
$${Err}_{LOO} = \frac{{\sum }_{j = 1}^{N} {( ℳ ( {x}^{( j )} ) - {ℳ}^{Krg \backslash j} ( {x}^{( j )} ) )}^{2}}{{\sum }_{j = 1}^{N} {( ℳ ( {x}^{( j )} ) - {\hat{μ}}_{Y} )}^{2}}$$
where M(x^{(j)}) is a sample value of the structural output response at the j^{th} sample point, M^{Krg\j}(x^{(j)}) is a predicted value of the structural output response of the Kriging model excluding the j^{th} sample point, and
$${\hat{μ}}_{Y} = \frac{1}{N} {\sum }_{j = 1}^{N} ℳ ( {x}^{( j )} )$$
is an average value of the structural output response sample set.
